(19) United States
(12) Patent Application Publication
(10) Pub. No.: US 2012/0089408 A1
(43) Pub. Date: Apr. 12, 2012

(54) Method and System for Providing a Fueling Solution for Electric Vehicle Owners

(75) Inventors: James Glen Stancil, Bellaire, TX (US); Jack Carmel Cannata, JR., Houston, TX (US); David Wayne Davenport, Richmond, TX (US)

(73) Assignee: NRG EV Services, LLC, Princeton, NJ (US)

(21) Appl. No.: 13/163,365

(22) Filed: Jun. 17, 2011

Related U.S. Application Data
(60) Provisional application No. 61/391,395, filed on Oct. 8, 2010.

(51) Int. Cl. G06Q 50/00; G06Q 10/00

(52) U.S. Cl. 705/1.1

(57) ABSTRACT

This invention relates generally to a method and system for providing a fueling solution for electric vehicle owners; and, more particularly, to integrating processes for home and away from home electric vehicle charging and billing into a single solution that does not require installation of a separate electric meter for the electric vehicle and enables the electric vehicle owner to understand and manage their total fueling costs. The invention utilizes a device to measure electricity usage, control access to electricity and transmit electricity usage data to enable an electricity provider to compensate an electric vehicle owner for the electricity used across a network of home and away from home chargers.

### CROSS REFERENCE TO OTHER APPLICATIONS

This application claims priority to U.S. Provisional Patent Application No. 61/391/395 entitled “Method and System for Providing a Fueling Solution for Electric Vehicle Owners” filed Oct. 8, 2010 which is incorporated herein by reference for all purposes.

### FIELD OF THE INVENTION

This invention relates generally to a method and system for providing a fueling solution for electric vehicle owners; and, more particularly, to integrating processes for home and away from home electric vehicle charging and billing into a single solution that does not require installation of a separate electric meter for the electric vehicle and enables the electric vehicle owner to understand and manage their total fueling costs.

### BACKGROUND

Electric vehicles with ranges that require charging after 40 to 100 miles of driving are being designed and manufactured by automobile manufacturers. Electric vehicle charging can be performed at charging stations that allow charging away from the home. These charging stations have limited existence today. Due to the limited range available with today's electric vehicles, electric vehicle drivers will rely on both the ability to charge at home as well as away from home. The cost of a home charging station can be $2,500 or more, with installation included. The expense of a home charging station is a potential barrier to the purchase of an electric vehicle.

The home charging dock utilizes the existing home electric meter, similar to any other device in the home. In some cases, a separate meter is being installed specifically for the electric vehicle home charging dock. Either case requires the electric vehicle home charging dock or at a minimum a dedicated electric circuit to be installed by a certified electrician. Installation of a separate home meter is expensive and state regulatory approval is required for the local utilities to purchase, install, and pay for the separate meters and charging docks through incorporation into ratepayer's charges.

The current fueling solution process for electric vehicles at home is shown in FIG. 1. The electric vehicle owner or home owner will contract with an electricity provider (the local utility or a retail electric provider in deregulated states) for electricity service step 101. An electric vehicle charging dock is installed at the home and either metered through the existing meter step 115 without separate usage data. Alternatively, an additional meter may be installed specifically for the electric vehicle charging dock step 111. Total household electricity usage, inclusive of the electric vehicle charging dock, is then measured by the meter step 125, either read manually or automatically with smart meters by the local utility or a contract agency. Alternatively, step 121 involves measuring exclusively the electricity usage from the home electric vehicle charging dock. An amount owed for the electricity used is calculated per the electricity contract based on current applicable rates steps 131 and 135. Such rates may be determined per an electricity agreement or alternatively per a utility tariff for regulated utilities and for the additional meter, the rates could be specific for electric vehicle charging. Then step 145, the electricity provider bills for electricity service without isolating the home electric vehicle charging dock usage and costs required to charge the electric vehicle. Without a second electric meter, the total charges for electricity fueling of the electric vehicle can not be identified. Step 141, the electricity provider bills for service and identifies the home electric vehicle charging dock usage and costs. The electric vehicle owner then makes payment to compensate the electricity provider to cover electricity serviced for the total household electricity usage Step 155 and alternatively payments would be made for the electricity from the additional meter dedicated to the home electric vehicle charging dock step 151.

Different electric rates are being proposed in some states and could be charged by the electricity provider for the electricity metered specifically for electric vehicle charging whether in the home or away from home.

In a few communities in the United States, public chargers are being offered through government grants that may allow for free or discounted access to encourage electric vehicle purchases. Given the government supported nature, this free or discounted charging system is not expected to continue. As shown in FIG. 2, the current away from home fueling solution process, a host provides an electric vehicle charging dock step 211. The host allows an electric vehicle owner access to charge an electric vehicle step 221. The host provides use of the electric vehicle charging station to charge electric vehicle step 231. The electricity used by the electric vehicle charging station dock is measured either through an existing meter or alternatively a dedicated meter for the electric vehicle charging dock step 241. The host is billed for service by the electricity provider step 251. Host makes payments to the electricity provider for the electricity used step 261. The electric vehicle owner may then be required to compensate the host for the charging service step 271 and at varying amounts.

Given the limited range of the electric vehicles, there is a need by electric vehicle drivers for an accessible network of charging stations away from home to provide electric vehicle drivers with confidence that a charge is always within a reasonable distance and the price to be charged by the stations is known with limited fluctuation. Additionally, the electric vehicle owner would like to know the cost of charging at home and away from home and manage the total fueling cost for the vehicle. Uncertainty exists among current or potential electric vehicle owners regarding pricing for individual charges by different charging station hosts and their ability to access these charging stations.

If the home electric vehicle charging dock is metered through the existing electric meters, the electricity usage for the vehicle would not be measured separately. Devices have been available to measure electricity usage of any specific piece of equipment and could be installed with the home electric vehicle charging docks. In fact, electric vehicle charging docks are available with the capability of measuring the electricity (kwh) utilized on a per event basis and transmitting such data. Further, electric vehicle charging docks are available with the ability to recognize and allow access for specific users (user authentication) as well as provide remote disabling of an electric vehicle charging dock.

While a host could bill an electric vehicle driver a flat rate for a single charging event, the host can not bill on a time based or usage rate for metered electricity. Many states prohibit (or make very difficult through detailed licensing and regulation requirements) for a host to resell the metered electricity. This creates a problem for electric vehicle owners that desire a minimal charge rather than a full charge.

### BRIEF DESCRIPTIONS OF THE DRAWINGS

FIG. 1 is a flowchart illustrating the current fueling solution process for electric vehicles at home.

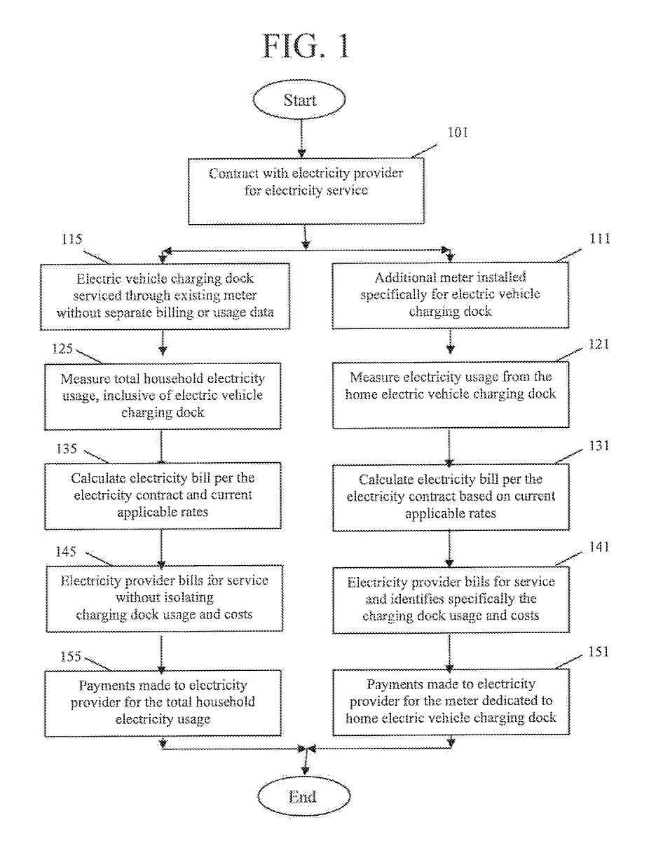

FIG. 2 is a flow chart illustrating the current fueling solution process of a host providing service for electric vehicles away from home.

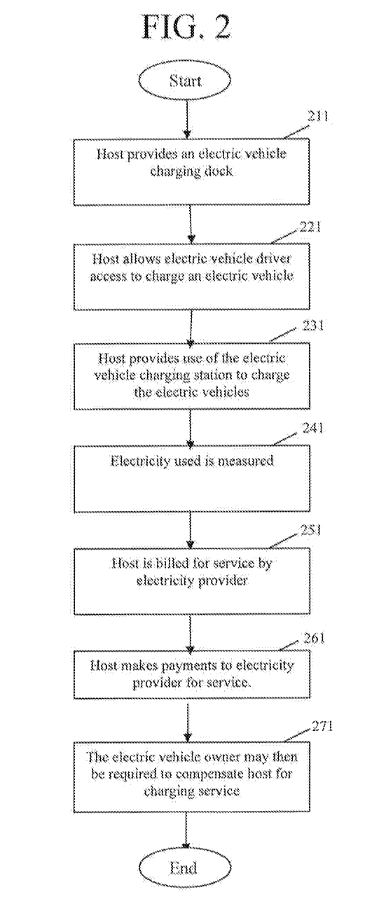

FIG. 3 is a flow chart illustrating an embodiment of a method for integrating a home fueling solution and an away from home fueling solution.

FIG. 4 illustrates the process involved in the calculation of the electricity used, communication of such related costs and the billing and related payments for the home electric vehicle charging dock electricity usage.

FIG. 5 illustrates the process involved in the calculation of the electricity used, communication of such related costs and the billing and related payments for the away from home electric vehicle charging dock electricity usage.

### SUMMARY OF THE INVENTION

This invention is a method and system that integrates a home fueling solution and an away from home fueling solution through the use of various items including: a device with capabilities including ability to measure electricity usage, control access to electricity and transmit electricity usage data; electric vehicle services agreement agreements with electric vehicle drivers and, separately with charging hosts; and a calculation tool. This invention enables an electric vehicle owner to manage their fueling solution costs at various network locations and at home and is able to do this without the need for a separate home utility meter dedicated to the home electric vehicle charging dock. The device may be an electric vehicle charging station, an electric vehicle capture device or an in-home smart outlet that allows for the measuring, controlling and transmitting of the electricity usage. The device can be configured to allow for charging only during off-peak hours, thus facilitating an electric vehicle owner to limit or eliminate load requirements during peak hours and allowing a customer to realize the benefit of Time of Use electricity rate plans that require off-peak usage. This can be accomplished without requiring a separate home electricity meter dedicated to the electric vehicle charging dock.

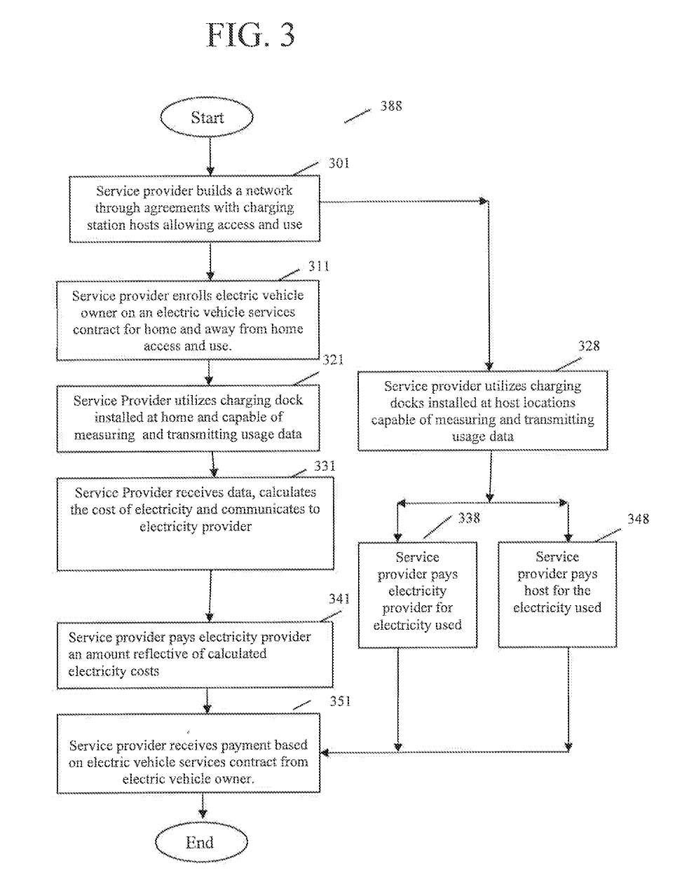

The invention is shown in FIG. 3 as item 388. The fueling solution method step 301 requires building a network of away from home charging options through agreements with charging station hosts allowing access and use. Such agreements allow access and use by selected users to the range of network charger locations.

The method involves enrolling a customer on an electric vehicle services contract, that provides access to and use of a network of charging stations away from home and at home step 311. This access involves the payment of a fixed fee to the service provider in exchange for a number of items that may include a) unlimited access to charging in the network; b) access to certain types of chargers; c) access to a certain number of sessions of charging; d) access to a fixed amount of miles; e) access during certain times of day and f) a variety of other configurations. The home charging dock is hosted by the electric vehicle owner, but the electric vehicle owner is not necessarily required to purchase the charging dock. Home charging docks, not owned by the electric vehicle owner, may be accessed by an electric vehicle owner as part of the network.

The service provider utilizes the device with the capability of measuring and controlling electricity and transmitting the electricity usage data for charging docks installed at home and host locations Steps 321 and 328. Usage data may include such items as electricity used per event in kwh, kilowatts, date and time of initiating such event and information regarding the electric vehicle driver accessing the charging dock. The home electric vehicle charging dock will be treated as another charging station within the electric vehicle owners network of charging possibilities.

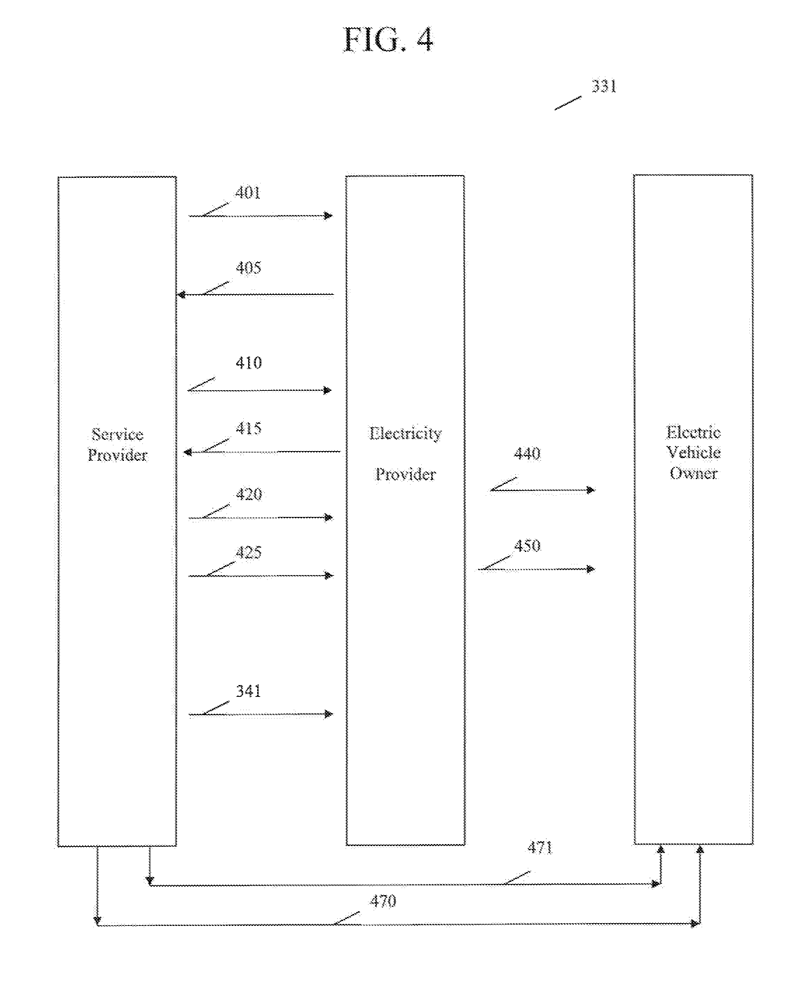

The service provider receives data, calculates the cost of electricity used and communicates with the electricity provider step 331. Step 331 detail is further shown in FIG. 4.

FIG. 4 shows data relevant to an initial enrollment of an electric vehicle owner on an electric vehicle services contract is sent to electricity provider Step 401. Data may include customer name and service address of the home electric vehicle charging dock. An electricity provider will then provide specific information confirming receipt of the enrollment. Data may include the meter identifier of the related electricity meter for the home electric vehicle charging dock as well as relevant customer account information Step 405.

Step 410 involves service provider providing data to electricity provider. Such data may include the payment period, the customer name, the service provider account number and the electricity provider account number. Step 415 involves the electricity provider submitting information to the service provider including the payment period, customer name, account status and electricity billing rate. Rates may also be determined based on tariffs in regulated utility areas.

Step 420 involves service provider providing a remittance file including a payment date, electricity provider account number and a payment amount calculated from tool based on the electricity usage from the home electric vehicle charging dock during the period.

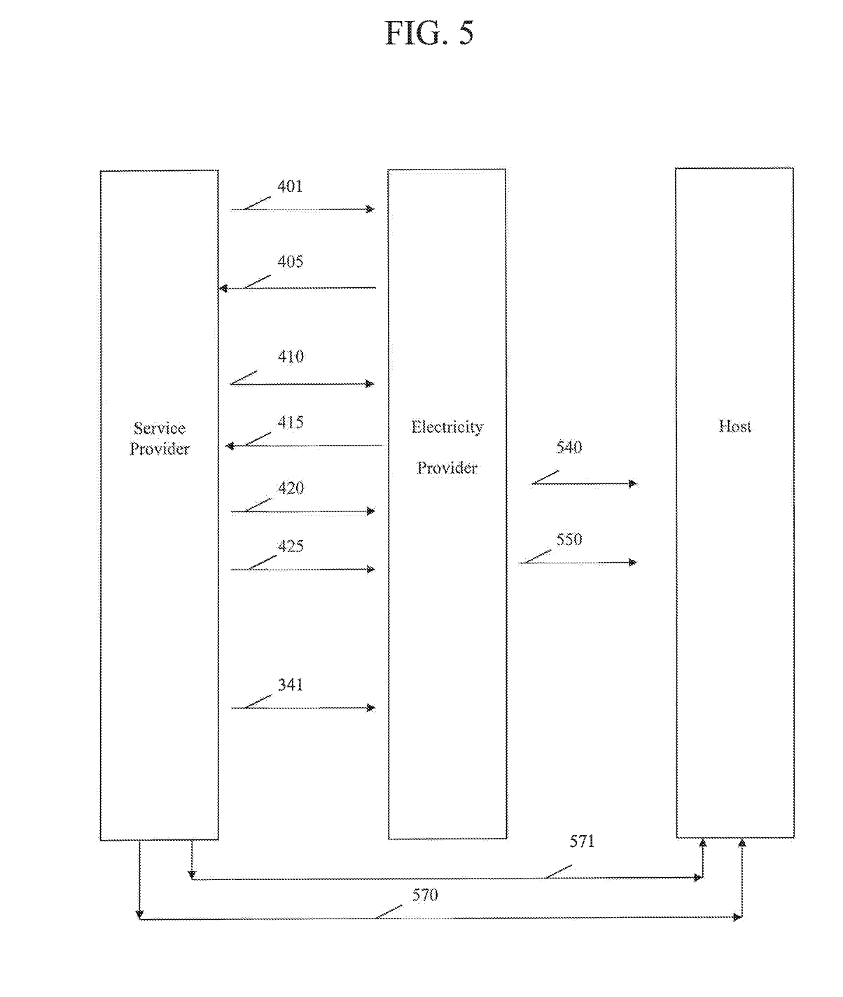

Step 425 includes supporting information and may be combined with step 420. Supporting information sent from service provider to electricity provider includes electricity provider account number or other identifying information, total volume of electricity used (kwh) during the period, KW, payment amount and information relative to hourly usage for example: off-peak and on-peak usage. Payment in step 341 is then made to electricity provider. This payment may be for the off peak usage only if such electricity usage from electric vehicle charging is controlled by the device to be restricted or limited to off peak charging. An amount relative to payment 341 is then credited to the customer account by the electricity provider. Step 450 may be incorporated where electricity provider applies custom payment line to customer's bill from electricity provider for total household usage and may provide volume and rate information. Likewise, in FIG. 5, Step 550 similarly involves a Host.

Alternatively in Step 470 service provider may send a communication directly to the customer with such usage information by email or other means. In one alternative, Step 471 involves service provider paying directly the electric vehicle owner. This payment may be for the off-peak usage only. In FIG. 5, similarly Step 570 service provider may send a communication directly to the host with such usage information by email or other means. In one alternative, Step 570 involves service provider paying directly the host. This payment may be for the off-peak usage only.

Step 338 involves the service provider paying the electricity provider directly for the electricity used. Alternatively, the service provider may pay the host or an electric vehicle owner directly for the electricity used Step 348. The Electricity Provider may be a local utility or a retail electricity provider in deregulated states.

The electric vehicle owner will pay for the home electricity metered except the off peak electric vehicle charging dock usage. Separately, the service provider will receive payment based on the electric vehicle services contract step 351 from the electric vehicle owner. The electric vehicle owner will also be able to understand and manage their costs for home and away from home charging within the network.

Although the foregoing embodiments have been described in some detail for purposes of clarity of understanding, the invention is not limited to the details provided. There are many alternative ways of implementing the invention. The disclosed embodiments are illustrative and restrictive.

We claim:

1. A method comprising:
a) building a network of away from home charging stations through agreements with charging station hosts that allows for electric vehicle owners to access and use a range of network charging station locations;
b) enrolling an electric vehicle owner on a electric vehicle services contract that provides access to and use of said network of electric vehicle charging stations including a home electric vehicle charging dock;
c) utilizing a device capable of measuring and controlling electricity usage and transmitting usage data;
d) receiving electricity usage and electricity rate;
e) calculating the cost of electricity through use of a calculation tool;
f) communicating such electricity usage and related electricity costs;
g) applying a payment to an electric vehicle owners electricity provider bill;
h) paying said payment to the electricity provider for the electric vehicle owner's home electric bill for said usage; and
i) receiving payments reflective of the electric vehicle services contract from electric vehicle owner.

2. A method according to claim 1, whereby tool is accessible directly by electricity provider and such usage data includes electricity used per event (kwh), date and time of initiating such event and information regarding the electric vehicle driver accessing the electric vehicle charging dock.

3. A method according to claim 1, whereby the electric vehicle services contract allows for unlimited access to the network of away from home chargers.

4. A method according to claim 1, whereby the device is an electric vehicle charging station.

5. A method according to claim 1, whereby the device is an electric vehicle capture device installed as part of the electric vehicle.

6. A method according to claim 1, whereby the device is an in-home smart outlet.

7. A method according to claim 2, whereby calculating costs step consists of:
a. sending customer enrollment information to electricity provider including name and service address of home electric vehicle charging dock;
b. receiving confirmation from electricity provider of such enrollment;
c. obtaining the appropriate usage rate to apply; and
d. calculating the electricity costs utilizing said tool and based on said usage rate.
f. communicating such electricity usage and related electricity costs;
g. applying a payment to an electric vehicle owners electricity provider bill; and
h. paying said payment to the electricity provider for the electric vehicle owners home electric bill for said usage;

8. A method according to claim 1, whereby the home electric vehicle charging station can be disabled when payments received are not according to the terms of the electric vehicle services contract.

9. A method according to claim 1, whereby the in-home smart outlet can be disabled when payments received are not according to the terms of the electric vehicle services contract.

10. A method of claim 1, whereby the electric vehicle services contract allows for fixed payment amounts.

11. A method of claim 2, whereby the electric vehicle services contract allows for fixed payment amounts.

12. A method consisting of:
a. building a network of away from home charging stations through agreements with charging station hosts that allows for electric vehicle owners to access and use a range of network charging station locations;
b. enrolling an electric vehicle owner on a electric vehicle services contract that provides access to and use of said network of electric vehicle charging stations including a home electric vehicle charging dock;
c. utilizing a device capable of measuring and controlling electricity usage and transmitting usage data;
d. receiving electricity usage and electricity rate;
e. calculating the cost of electricity through use of a calculation tool;
f. applying a payment for a host's electricity provider bill;
g. communicating such electricity usage and related electricity costs; and
h. paying said payment to a host for the host's electric bill or that portion of a host's electric bill related to the charging dock usage.

13. A system for providing an integrated fueling solution for home and away from home, the system comprising:
a. a device;
said device having the capability of measuring electricity usage data, controlling electricity usage and transmitting said usage data;
b. a tool to calculate a payment and to allow access by the electricity provider to calculate a payment based on said data usage and applicable electricity rates;
c. a tool to then transmit said payment to the electricity provider for calculation and inclusion in the electric vehicle owners bill;
d. a tool to calculate a payment and to allow access by the electricity provider to calculate a payment based on said data usage and applicable electricity rates;
e. a billing system to bill the electric vehicle owner according to the electric vehicle services contract and to receive such payments.

14. A system according to claim 13, whereby the home electric vehicle charging station can be disabled when payment issues are encountered and stop access to electric vehicle charging for specific users.

15. A system according to claim 13, whereby the in-home smart outlet can be disabled when payment issues are encountered and stop access to electric vehicle charging for specific users.

16. A system according to claim 13 wherein a device allows for recognizing the electric vehicle being charged and allowing access only to pre-determined users.

17. A system for providing an integrated fueling solution for home and away from home, the system comprising:
a. a device;
said device having the capability of measuring electricity usage data, controlling electricity usage and transmitting said usage data;
b. a tool to calculate a payment and to allow access by the electricity provider to calculate a payment based on said data usage and applicable electricity rates;
c. a tool to then transmit said payment to the electricity provider for calculation and inclusion in a host's electric bill;
d. a tool to calculate a payment and to allow access by the electricity provider to calculate a payment based on said data usage and applicable electricity rates;
e. a billing system to bill the electric vehicle owner according to the electric vehicle services contract and to receive such payments.
